(19) United States
(12) Patent Application Publication
(10) Pub. No.: US 2004/0062708 A1
(43) Pub. Date: Apr. 1, 2004

(54) Process for the synthesis of nanotubes of transition metal dichalcogenides

(76) Inventors: Maja Remskar, Brezovica (SI); Ales Mrzel, Ljubljana (SI); Zora Skraba, Ljubljana (SI); Dragan D. Mihailovic, Ljubljana (SI); Igor Musevic, Ljubljana (SI)

Correspondence Address: CONNOLLY BOVE LODGE & HUTZ LLP, SUITE 800, 1990 M STREET NW, WASHINGTON, DC, 20036-3425, US

(21) Appl. No.: 10/398,759

(22) PCT Filed: Oct. 8, 2001
(86) PCT No.: PCT/SI01/00027

(30) Foreign Application Priority Data
Oct. 10, 2000 (SI) P-200000245

(51) Int. Cl. C01F 1/00

(52) U.S. Cl. 423/561.1

(57) ABSTRACT

A process of the synthesis of nanotubes of transition metal dichalcogenides by chemical transport with the addition of fullerences is provided to obtain nanotubes of transistion metal dichalcogenides. The nanotubes are hexagonally arranged in form of needle-like bundles. The process comprises chemical transport, in which the fullerences exist in the vapour phase. The chemical fullerences are used at conditions, in which the fullerences exist in the vapour phase. The chemical transport reaction occurs in a quartz ampoule, sealed at a pressure lower than 0.66 Pa. The temperature in the hot part of the ampoule is higher than 830° C.

### OBJECT OF THE INVENTION, TECHNICAL FIELD, TO WHICH THE INVENTION BELONGS

The object of the invention is a process for the synthesis of nanotubes of transition metal dichalcogenides by the method of chemical transport with addition of fullerenes. The invention is in the field of inorganic chemistry, carbon chemistry and of the chemistry of transition metal dichalcogenides. The invention relates to, the synthesis of nanotubes of transition metal dichalcogenides by the method of chemical transport with the addition of fullerenes. This process enables the synthesis of nanotubes of transition metal dichalcogenides.

### TECHNICAL PROBLEM

Transition metal dichalcogenides TX₂, where T is a transition metal (e.g., tungsten, molybdenum, zirconium, hafnium, titanium, rhenium, niobium etc.) and X is a chalcogen (e.g., selenium, sulphur etc.) are layer crystals, where the layers of a transition metal and a chalcogen alternate in the sequence of XTXXTX.

In last few years it was observed that under certain synthesis conditions some dichalcogenides of transition metals form spherical and cylindrical forms. Thus onion-like forms—described in Y. Feldman et al., Science 267, 111 (1995), L. Margulis et al., Nature 365, 113 (1993) and R. Tenne, Adv. Mater. 7, 965 (1995) and WS₂ and MoS₂ nanotubes—described in A. Rothschild et al., J. Meter. Innov 3, 145 (1999), M. Remskar et al., App. Phys. Left. 74, 3633 (1999) and M. Remskar et al., App. Phys. Lett. 69, 351 (1996), were discovered. On heating thin films of oxides of transition metal dichalcogenides in H₂S stream, inorganic structures, similar to the fullerenes, are also formed—described in R. Tenne et al., USA Patent Base: U.S. Pat. No. 5,958,358, 28, Sep. (1999).

Some transition metal dichalcogenides are technologically very important compounds (e.g., MoS₂, WS₂) in different fields (e.g., lubricants, catalysts). Potentially, transition metal dichalcogenides are useful for electrochemical and photovoltaic sun cells—described in H. D. Abruna and A. J. Bard, J. Electrochem. Soc. 129, 673 (1982) and G. Djemal et al., Sol. Energy Mater. 5, 403 (1981), battery cathodes—described in J. Rouxel and R. A. Brec, Rev. Mater. Sci., 16, 137, (1986), catalysts—described in R. R. Chianelli, Catal. Rev. Sci. Eng. 26, 361 (1984) and lubricants—described in H. Dimigen et al., Thin Solid Films, 64, 221 (1979).

The investigations of microcrystalline and nanocrystalline semiconductors became very intensive recently, as optical and electronic properties differ from those in monocrystals. Magnetic, chemical and mechanical properties depend very much on the particle size. Controlling not only the size, but also the structure itself, particles with very interesting properties could be obtained—described in A. P. Alivisatos, J Phys. C. 100, 13 226 (1996) and B. Murray et al., J. Am. Chem. Soc. 115, 8706 (1993).

Thus, for instance MoS₂ and WS₂ particles, similar to inorganic fullerenes, are very promising for solid lubricants—described in Y. Rapoport, et al., Nature, 387, 791 (1997). Theoretical calculations show, that MS₂ nanotubes having appropriate diameter and appropriate chirality could also be light emitters and therewith useful in electro—optical devices—described in G. Seifert et al., Phys. Rew. Lett. 88, 146 (2000).

WS₂ nanotubes used as tips in atomic force microscopes have been shown to improve the image quality—described in A. Rothschild, Appl. Phys. Lett. 75, 4025, (1999).

A technical problem is the synthesis of macroscopic quantities of undamaged nanotubes of transition metal dichalcogenides with equal diameters and without admixtures of additional forms of transition metal dichalcogenides (e.g., layer crystals, onion-like forms or of structures, similar to fullerenes).

### STATE OF THE ART

MoS₂ and WS₂ nanotubes were synthesized by some different ways—by the chemical transport method—described in M. Remskar et al., App Phys. Lett. 74, 3633 (1999) and M. Remskar et al., Appl Phys. Lett. 69, 351 (1996), by heating thin films of oxides of transition metal dichalcogenides in H₂S stream—described in R. Tenne, et al., U.S. Pat. No. 5,958,353 Sept. 28 (1999) and A. Rotschild et al., J. Meter. Innov 3, 145 (1999), by heating porous aluminium, previously wetted in the solution of ammonium thiomolybdate at 450° C.—described in C. M. Zelenski et al., J. Am. Chem. Soc., 120, 734 (1998).

By the chemical transport method the majority of transported material is obtained in form of layer crystals, and the tubes are of different diameters (typically from 20 nm to 10 μm); however, by other methods the nanotubes are deformed very often. The methods known until now do not enable the synthesis of macroscopic quantities of quality homogeneous nanotubes of transition metal dichalcogenides.

Japanese, European and American patent bases and the publications from the year 1991 onwards were examined, however, no method has been known and described up to now for the synthesis of tubes of transition metal dichalcogenides by the chemical transport method with addition of the fullerenes, as described here.

### TASK AND AIM OF THE INVENTION

The task and aim of the invention is the synthesis of nanotubes of transition metal dichalcogenides.

According to the invention the task is solved by the process for the synthesis of nanotubes of transition metals according to the independent patent claim.

### DESCRIPTION OF THE SOLUTION OF THE PROBLEM

The invention will be described by an example, an experiment and shown by the Figures illustrating:

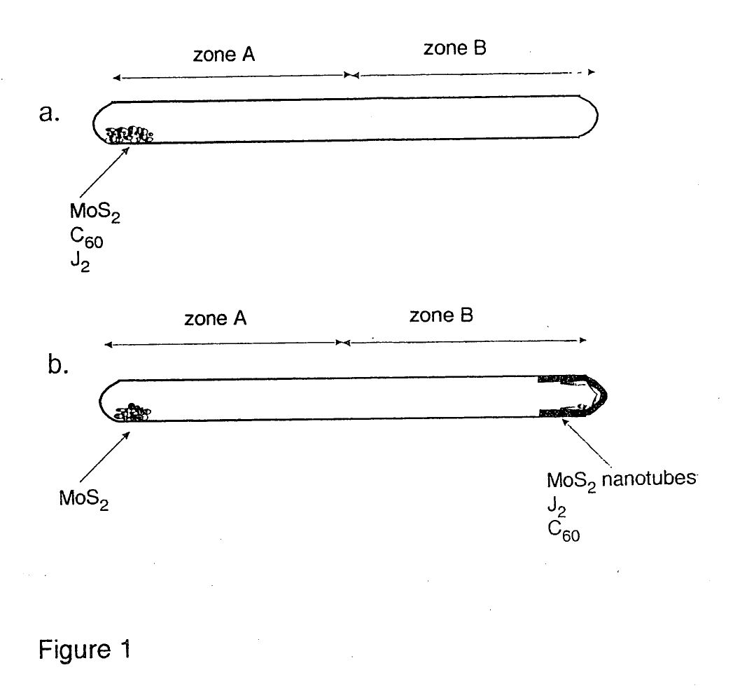

FIG. 1a: a schematic presentation of a quartz ampoule before the transport reaction.

FIG. 1b: a schematic presentation of a quartz ampoule after the transport is terminated.

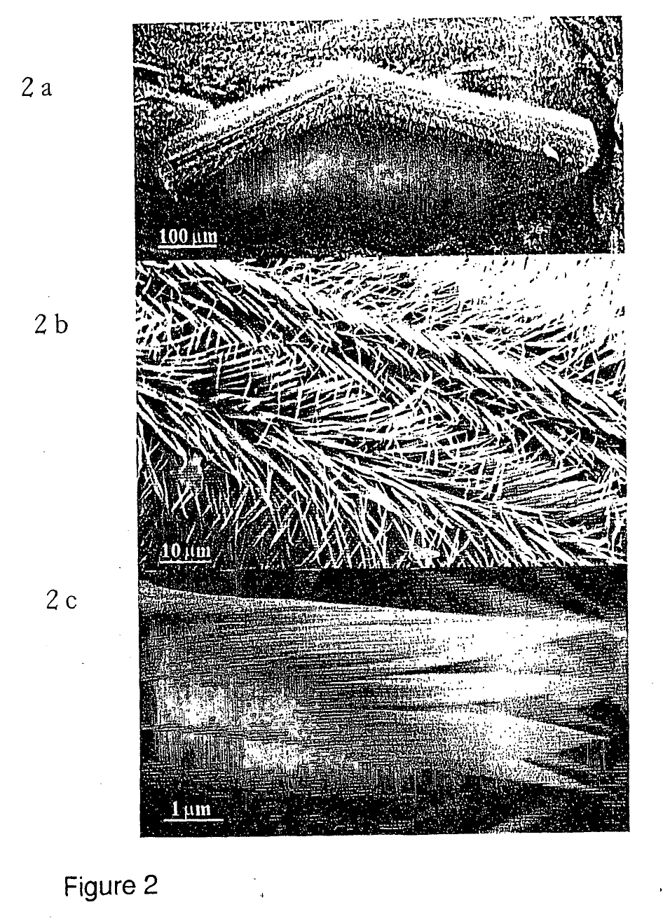

FIG. 2a: a scanning electron image of the surface of transported material: self-ordering of nanotube bundles into micron scale structures.

FIG. 2b: a scanning electron image of the surface of the transported material: ordered growth of nanotube bundles.

FIG. 2c: a scanning electron image of the surface of the transported material: a typical ending of the nanotubes bundles.

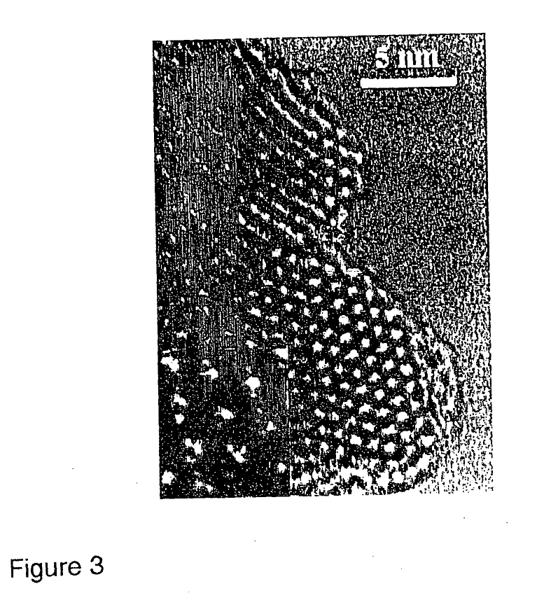

FIG. 3: high resolution transmission electron microscopy image of the nanotubes bundles in the longitudinal direction.

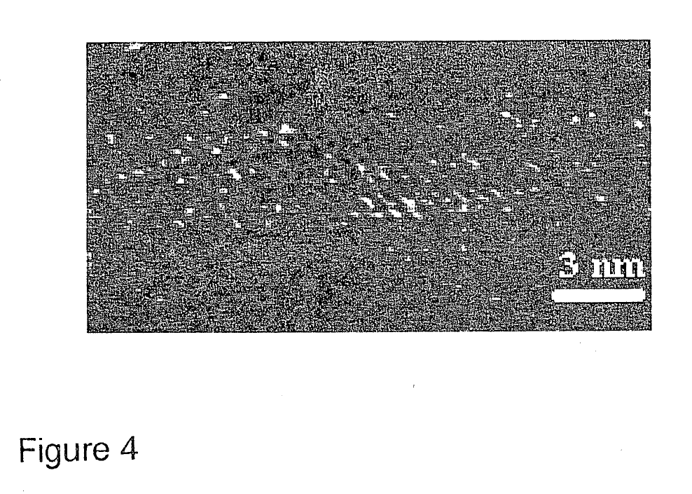

FIG. 4: by transmission electron diffraction a diffraction pattern is obtained, revealing congruent growth of individual fibres—nanotubes in a crystal structure.

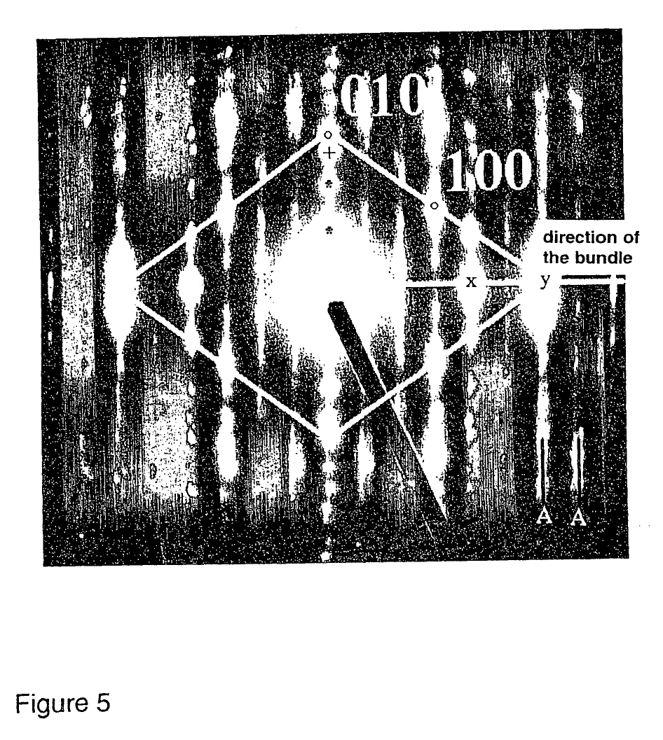

FIG. 5: transmission electron diffraction image shows a bundle of parallel MoS₂ nanotubes, with atomic resolution.

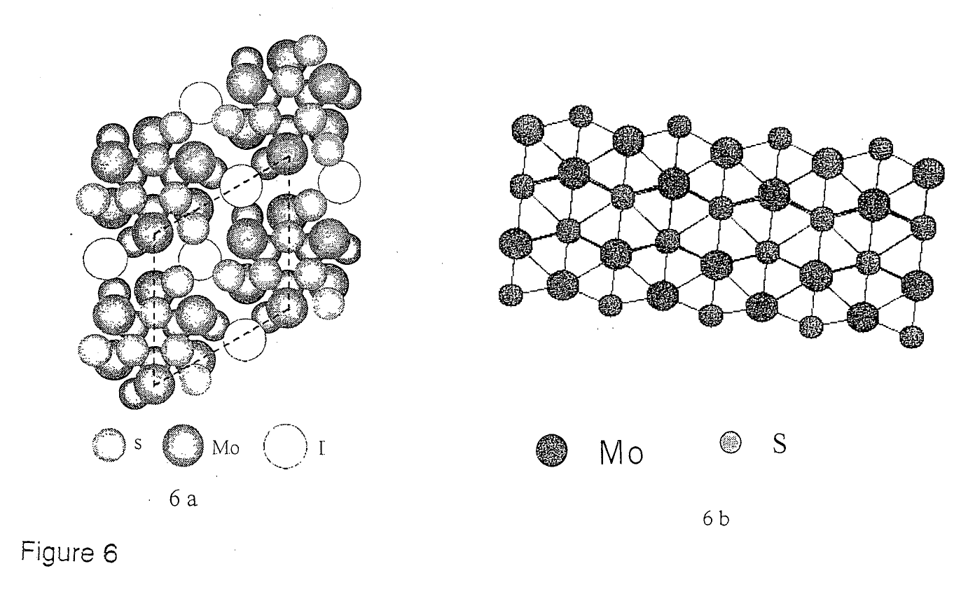

FIG. 6a: a model of tubes: cross-sectional section of ordered MOS₂ nanotubes.

FIG. 6b: a model of tubes: the model of individual MOS₂ nanotubes.

The technical problem described previously can be solved by the chemical transport method with the addition of fullerenes. Chemical transport reaction is based on the fact that in the system, in which the solid is in equilibrium with several vapour components, material transfer occurs if the equilibrium in the system varies, for instance if there exists a certain temperature gradient—as described in R. Nitsche, J. Phys. Chem. Solids 17, 163 (1960).

The reaction was performed in an evacuated quartz ampoule, into which a previously synthesized TX₂ compound, iodine (I₂) and C₅₀ were introduced. The reaction was performed in a three-zone oven. The iodine sublimed at the higher temperature and the chemical equilibrium TX₂+I₂≈TI₂+X₂ was established. Due to the temperature gradient the TI₂ molecules were transported to the cooler end of the ampoule (FIG. 1, zone B), where due to the lower temperature the transition metal combined again with the gasified chalcogen to TX₂, while the released iodine participated partly again in the transport and partly was built into the transported material. In the process of growth in the cooler part of the zone B, the formation of MoS₂ nanotubes occurred with the iodine built in the channels between the tubes.

An Example of the Synthesis of Nanotubes of Transition Metal Dichalcogenides

The Synthesis of MoS₂ Nanotubes

MoS₂ nanotubes were synthesized according to the iodine transport method with the addition of the fullerene C₆₀. It is known, that under certain conditions of the iodine transport reaction (without the addition of a fullerene) apart from layer crystals, also MoS₂ microtubes are formed—described in M. Remskar et al.; Appl. Phys. Lett. 69, 351 (1996).

The transport method of this kind in combination with fullerenes has not been used for the nanotubes growth up to now.

### EXPERIMENT

1. Synthesis of MOS₂

Into the quartz ampoule, having a diameter of 16 mm and length of 130 mm, 1.799 g of molybdenum thin sheet and 1.202 g of the sublimed sulphur powder were introduced and the ampoule was evacuated to 7×10⁻⁵ Torr. Then the ampoule was inserted in a Lindberg oven STF 55346C in such a manner, that the material was uniformly dispersed over the whole ampoule. Due to the strong exothermic reaction between the elements the ampoule was slowly (5° C./h) heated to 850° C. After 72 hours at 850° C. the cooling was started with 17° C./h until room temperature is reached. When the ampoule was cooled, it was strongly shaken several times and was introduced into the oven again for homogenizing. The ampoule was heated once again to 850° C., this time with the heating rate of 34° C./h, it was left there for 144 hours and cooled to 50° C. with a rate of 17° C./h. By this the molybdenum disulphide synthesis was finished.

2. Synthesis of the MoS₂ Nanotubes

Into the quartz ampoule having a diameter of 1.9 cm and length of 20 cm, 0.610 g of MoS₂, synthesized according to the above described procedure, 0.028 g of C₆₀, and 0.313 g of I₂were supplied. The ampoule was evacuated to a pressure of 2.5×10⁻¹ Torr and sealed. The initial MoS₂ from the zone A was gradually transported into the zone B (FIG. 1). The growth process can be divided into two parts: into the thermal cleaning of the zone B and into the chemical transport reaction. The synthesis process was carried out in a three-zone oven

Growth process

1. Thermal Cleaning:

The ampoule was heated in such a manner, that the temperature in the zone B was higher than in the zone A and by that the zone B, in which the crystal growth of the transported material takes place, was cleaned. Within 24 hours the zone A was heated up to a temperature of 875° C. (0.59° C./min), and the zone B was heated up to a temperature of 900° C. (0.6° C./min). Both zones reached the mentioned temperatures simultaneously. After 24 hours the cooling was started. The zone A was cooled to a temperature of 850° C. in steps of 0.02° C./min, and zone B was cooled to a temperature of 736° C. in steps of 0.11° C./min.

2. Chemical Transport Reaction

The chemical transport reaction occurred with the material transfer from zone A, heated to 850° C., into the zone B, heated to 736° C. The reaction was carried out for 3 weeks, then the ampoule was slowly cooled to room temperature: The zone A with the cooling rate of 0.28° C./min and the zone B with a cooling rate of 0.25° C./min. Approximately 7% of the MoS₂ starting material was transported, which was collected on the last few centimeters of the zone B in the form of a thin foil. The iodine and C₆₀ are removed by dissolution in CS₂ and the foil thus obtained is rinsed with hexane and dried at room temperature in a vacuum.

Structural and chemical analyses

1. Energy Dispersive X-ray Spectroscopy (EDX)

Energy dispersive X-ray spectroscopy, performed on a microscope TEM-Jeol 2000 FX shows that the material consists of molybdenum, sulphur and iodine.

2. X-ray Fluorescence Spectrometry

By X-ray fluorescence spectrometry it is obtained, that the content of molybdenum and sulphur in the specimen is in the molar ratio of 1:2 (MOS₂), however, also about 20 weight % of the iodine is found. The fullerene C₆₀ is not noticed by ionization mass spectrometry.

3. Scanning Electron Microscopy (SEM) (FIG. 2)

The thin foil consists of needle-like bundles growing perpendicularly to the quartz substrate and ending in the form of tips. The typical diameter of an individual bundle is 0.5 micrometer, and the lengths are some tens of micrometers. In the image taken with a SEM Philips XL 30FEG, the tendency of self-arrangement (FIG. 2a), the congruent growth of individual bundles (FIG. 2b), and the typical bundle endings (FIG. 2c) can be observed. Visible is also the further assembly of bundles and spiral twisting of the constituents of an individual bundle. 4. High Resolution Transmission Electron Microscopy (HRTEM) (FIG. 3), (FIG. 4)

High resolution transmission electron microscopy with 300 keV Philips CM 300 showed that an individual bundle consists of close-packed hexagonally arranged fibres having equal diameters. The distance between the longitudinal axes of two neighbouring fibres is 0.96 nm. The distance between the planes of fibres is 0.83 nm, which is in accordance with the results of transmission electron diffraction and with the results of X-ray spectroscopy.

The bundles of tubes can be simply disassembled into individual constituents—nanotubes. A thin foil was dispersed for one hour in ultrasound in ethanol and the suspension obtained was taken with Jeol JEM-2010F. FIG. 4 shows a bundle of parallel nanotubes, with atomic resolution. The angle between the rows of atoms and the tube axis is 60, which uniformly defines the nanotube type.

5. Transmission Electron Diffraction (TED) (FIG. 5) and X-ray Diffraction

By transmission electron diffraction a diffraction pattern is obtained, revealing the congruent growth of individual fibres—nanotubes into the crystal structure (FIG. 4). A very long period with the size of 1.2 nm (A-A) is present in the longitudinal direction of the bundle as a result of the superposition of two strong individual periods: 0.2 nm (y) and 0.3 nm (x). Perpendicularly to the longitudinal axis in the bundle a dominant period of 0.83 nm (denoted by *) is obtained, which represents the shortest distance between the nanotubes planes. The partly deformed hexagonal network of reflections with indexes belongs to the sum of diffractions on individual nanotubes. The reflection 010, defining the interplanar spacing of 0.27 nm, overlaps with one of the reflections, belonging to the already mentioned period of 0.83 nm. Furthermore, a strong signal is obtained under the spot (010) which is the result of the 0.31 nm period. In the diffraction specter the intensive peaks are obtained at distances, corresponding to interplanar spacings: 0.35 nm, 0.315 nm, 0.28 nm and 0.2 nm (FIG. 5).

6. Model (FIG. 6)

All results obtained experimentally can be explained by a model, where monolayer MoS₂ nanotubes consist of sulphur-molybdenum-sulphur cylinders (FIG. 6a). By considering the covalent radii of atoms the diameter of the inner sulphur cylinder is 0.32 nm, that of the molybdenum is 0.58 nm and that of the outer sulphur cylinder is 0.75 nm. The diameter of the inner hole is 0.1 nm. The thickness of the wall corresponds to the thickness of the triple S—Mo—S layer in the MoS₂ layer crystal, which is 0.319 nm. Also the length of the bond between molybdenum and sulphur is equal as in the layer crystal. The dihedral S—Mo—S angle for the inner and outer layers is 63° and 66° respectively, while in the layer crystal it is 81.5°. The increase of the unit cell results in a decrease of angle by 9°: while the additional 6° (the inner layer) or 9° (the outer layer), are the result of the modified geometry. The vicinity of the molybdenum and sulphur atoms in neighbouring (110) layers requires an extension of the unit cell along the tube axis by about 33%. The coordination of the molybdenum atom can be explained by the deformed trigonal prismatic or deformed octahedral arrangement. Both explanations are equivalent in the model.

The MoS₂ nanotubes are hexagonally arranged in the bundle. The sulphur atoms of neighbouring nanotubes are separated by 0.35 nm (FIG. 6). The iodine atoms being separated at least 0.43 nm from each other are placed in trigonal voids between the nanotubes. The nanotubes are collectively shifted along their axis for ¼ of the cell length.

Temporal Stability and Synthesis Repeatability

MOS₂ nanotubes are stable in air under normal room conditions. The stability of the compound and the synthesis repeatability were controlled by transmission electron diffraction.

In summary, the process for the synthesis of the nanotubes of transition metal dichalcogenides comprises the synthesis of nanotubes of transition metal dichalcogenides by the method of chemical transport, in which beside the halogens iodine and/or bromine also fullerenes are used under conditions, in which the fullerenes exist in the vapour phase. The form of nanotubes is in form of needle-like bundles of nanotubes, composed of hexagonally arranged nanotubes of transition metal dichalcogenides. The chemical transport occurs in a quartz ampoule. Pressure in the ampoule at the sealing of the ampoule is lower than 5×10⁻³ Torr. The temperature in the hot part of the ampoule in the course of the chemical transport is higher than 830° C.

1. A process for the synthesis of nanotubes of transition metal dichalcogenides, characterized in that it comprises the synthesis of nanotubes of transition metal dichalcogenides by the method of chemical transport, in which besides the halogens iodine and/or bromine also fullerenes are used under conditions, in which the fullerenes exist in the vapour phase.

2. A process according to claim 1, characterized in that the nanotube form is in the form of needle-like bundles of nanotubes, composed of hexagonally arranged nanotubes of transition metal dichalcogenides.

3. A process according to claim 1, characterized in that the chemical transport occurs in a quartz ampoule.

4. A process according to claim 1, characterized in that the pressure in the ampoule upon sealing of the ampoule is lower than 5×10⁻³ Torr.

5. A process according to claim 1, characterized in that the temperature in the hot part of the ampoule in the course of chemical transport is higher than 830° C.
